(19) United States
(12) Patent Application Publication
(10) Pub. No.: US 2026/0197802 A1
(43) Pub. Date: Jul. 9, 2026

(54) METHODS AND ARCHITECTURE FOR EDGE SERVICES SHARING OVER A LOCAL CONNECTION

(71) Applicant: InterDigital Patent Holdings, Inc., Wilmington, DE (US)

(72) Inventors: Michel Roy, Candiac (CA); Kevin DI LALLO, Laval (CA); Michael STARSINIC, Newtown, PA (US); Ulises OLVERA-HERNANDEZ, Saint-Lazare (CA); Robert GAZDA, Spring City, PA (US)

(73) Assignee: InterDigital Patent Holdings, Inc., Wilmington, DE (US)

(21) Appl. No.: 19/132,283

(22) PCT Filed: Nov. 22, 2023
(86) PCT No.: PCT/US2023/080952

§ 371 Date: May 22, 2025

Related U.S. Application Data
(60) Provisional application No. 63/427,230, filed on Nov. 22, 2022.

(51) Int. Cl. H04W 72/02; H04W 8/00; H04W 12/06; H04W 60/04

(52) U.S. Cl. CPC H04W 72/02; H04W 8/005; H04W 12/06; H04W 60/04

(57) ABSTRACT

A system and method for providing an Edge Sharing Service via a local connection is disclosed. This includes reserving resources for a locally connecting device responsive to a registration request from the device, discovering and connecting to at least one edge data network providing services required by the locally connecting device, selecting an edge application server (EAS) and service continuity method on behalf of the locally connecting device, and providing registration response to the device to allow the locally connecting device to access edge services over the local connection using the reserved resources for the device. This includes requesting Edge Sharing Function via an edge enabler client (EEC) registration and receiving an EEC response, authenticating and authorizing the device to access edge services, discovering edge services, providing the device with the address of the selected EAS, and configuring the required connectivity for the device to access the EAS.

### CROSS-REFERENCE TO RELATED APPLICATIONS

This application claims the benefit of U.S. Provisional Application No. 63/427,230, filed Nov. 22, 2022, the contents of which are incorporated herein by reference.

### SUMMARY

3GPP SA6 defines an Edge Enablement Layer (EEL) architecture that allows the Application Clients (AC) present on a WTRU to access Edge Computing (EC) resources hosted in the mobile network. A WTRU can share their network connectivity with locally connecting devices (Wi-Fi, Bluetooth, USB, Eth, etc.). Described herein is provisioning of an Edge Sharing Function (ESF) on a connection providing WTRU, provisioning of an Edge Sharing Service (ESS) offered by a connection providing WTRU, implicit usage of EC services via registration to an ESS, implicit usage of EC services via DNS for ESS unaware devices and explicit usage of EC services through an ESS.

A system and method for providing an Edge Sharing Service (ESS) via a local connection is disclosed. The system and method include reserving resources for a locally connecting device responsive to a registration request from the device, discovering and connecting to at least one edge data network (EDN) providing services required by the locally connecting device, selecting an edge application server (EAS) and service continuity method on behalf of the locally connecting device, and providing registration response to the locally connecting device to access edge services over the local connection using the reserved resources for the device. The system and method further include requesting Edge Sharing Function (ESF) via an edge enabler client (EEC) registration and receiving an EEC response. The system and method further include authenticating and authorizing the device to access edge services. The system and method further include discovering edge services on behalf of the device. The system and method further include providing the device with the address of the selected EAS. The system and method further include configuring the required connectivity for the device to access the EAS.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates the SA6 Architecture for enabling edge applications;

FIG. 3 illustrates an illustration of edge sharing;

FIG. 4 illustrates a signaling diagram illustrating example alternatives for provisioning an ESF;

FIG. 5 illustrates a signaling diagram illustrating alternatives for non-advertised ESS provisioning;

FIG. 6 illustrates advertised provisioning alternatives;

FIG. 7 illustrates the explicit registration of a device to an ESF;

FIG. 8 illustrates the implicit registration of a device;

FIG. 9 illustrates various alternatives that device with EEC capabilities can have through an ESS; and

FIG. 10 illustrates a method performed in a wireless transmit receive unit (WTRU) for providing an Edge Sharing Service (ESS) via a local connection.

### DETAILED DESCRIPTION

New Edge Computing (EC) use cases are emerging as the edge enablement layer becomes widely available in mobile networks and is used by the mobile terminal applications. As described herein, procedures are provided that can be used by an edge enabled terminal device, with access to edge services that may be provided by a mobile network, to share the available edge services with other devices. The present examples include methods for provisioning information in an Edge Sharing Function (ESF) on an edge enabled terminal device. The information is used by the Edge Sharing Function so that the edge enabled terminal device can offer an Edge Sharing Service (ESS) to other devices.

The present examples include methods for provisioning information of an Edge Sharing Service on devices. The Edge Sharing Service information is used by the device to access edge services via the edge enabled terminal device.

The present examples include methods for registering to an Edge Sharing Service. Registering to an Edge Sharing Service may involve the device sending a message to the Edge Sharing Function in the edge enabled terminal device. The message may include information about the device (e.g. a user identifier, a device identifier and a contact address). The registration may cause the Edge Sharing Function to perform a series of interactions with the edge enablement layer on behalf of the device. From the connecting device point of view, the ESF may perform implicit interactions with the edge enablement layer because the interactions are originating at the Edge Sharing Function as a result of a device registration and the connecting device is unaware of these interactions with the edge network.

The present examples include methods for allowing a device to interact explicitly with an edge enabled network through an Edge Sharing Service. A device may interact explicitly with the edge enablement layer through the Edge Sharing Function by sending messages that may be modified and forwarded to the edge enablement layer. From the connecting device point of view, the ESF performs explicit interactions with the edge enablement layer because the interactions are originating at the connecting device which is aware of these interactions with the edge network.

A system, device and method are provided. The system, device and method include a method performed in a wireless transmit receive unit (WTRU) for providing an Edge Sharing Service (ESS) via a local connection. The method includes reserving resources for a locally connecting device responsive to a registration request from the locally connecting device, discovering and connecting to at least one edge data network (EDN) providing services required by the locally connecting device, selecting an edge application server (EAS) and service continuity method on behalf of the locally connecting device, and providing registration response to the locally connecting device to allow the locally connecting device to access edge services over the local connection using the resources reserved for the device. The method may further include requesting Edge Sharing Function (ESF) via an edge enabler client (EEC) registration and receiving an EEC response. The EEC response may include connectivity information allowing the locally connecting device to access a service provided by the selected EAS. The method may further include authenticating and authorizing the device to access edge services. The method may further include discovering edge services on behalf of the locally connecting device. The method may further include providing the locally connecting device with an address of a selected EAS. The method may further include configuring the required connectivity for the locally connecting device to access the EAS. The resources reserved for the device may include at least one of processing, memory and a configuration needed to keep the registration alive. The resources reserved for the device may enable discovery of the EDN/EAS, enable the locally connecting device traffic to be sent to the EDN/EAS, and enable service continuity. The service continuity may include connectivity with the EDN/EAS managed as the WTRU moves and a new EDN/EAS needs to be selected.

A wireless transmit receive unit (WTRU) for providing an Edge Sharing Service (ESS) via a local connection is also disclosed. The WTRU includes a transceiver and a processor communicatively coupled to the transceiver. The transceiver and the processor operate to reserve resources for a locally connecting device responsive to a registration request from the locally connecting device, discover and connect to at least one edge data network (EDN) providing services required by the locally connecting device, select an edge application server (EAS) and service continuity method on behalf of the locally connecting device, and provide registration response to the locally connecting device to allow the locally connecting device to access edge services over the local connection using the resources reserved for the device. The transceiver and the processor may further operate to request Edge Sharing Function (ESF) via an edge enabler client (EEC) registration and receiving an EEC response. The EEC response may include connectivity information allowing the locally connecting device to access a service provided by the selected EAS. The transceiver and the processor may further operate to authenticate and authorize the device to access edge services. The transceiver and the processor may further operate to discover edge services on behalf of the locally connecting device. The transceiver and the processor may further operate to provide the locally connecting device with an address of a selected EAS. The transceiver and the processor may further operate to configure the required connectivity for the locally connecting device to access the EAS. The resources reserved for the device may include at least one of processing, memory and a configuration needed to keep the registration alive. The resources reserved for the device may enable discovery of the EDN/EAS, that the locally connecting device traffic is sent to the EDN/EAS, and service continuity. The service continuity may include connectivity with the EDN/EAS managed as the WTRU moves and a new EDN/EAS needs to be selected.

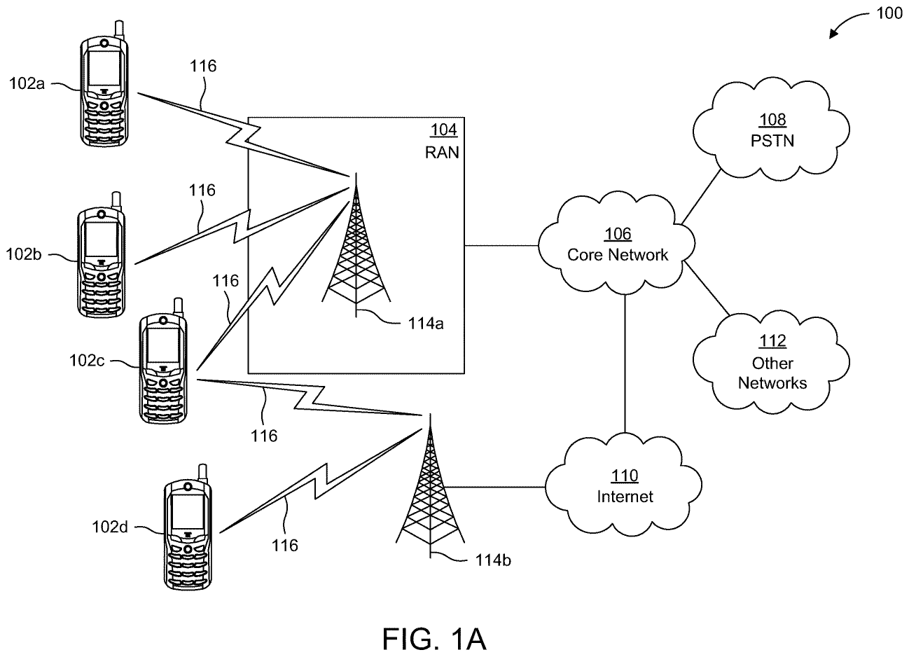

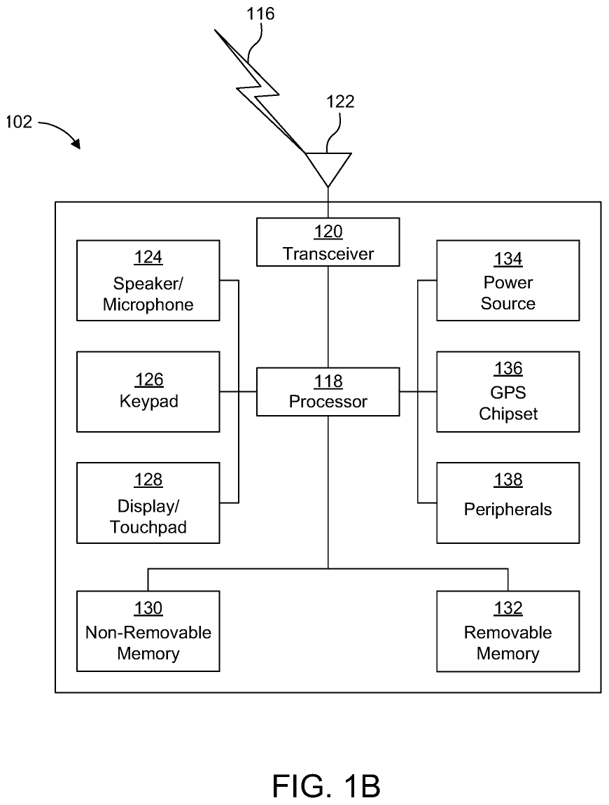

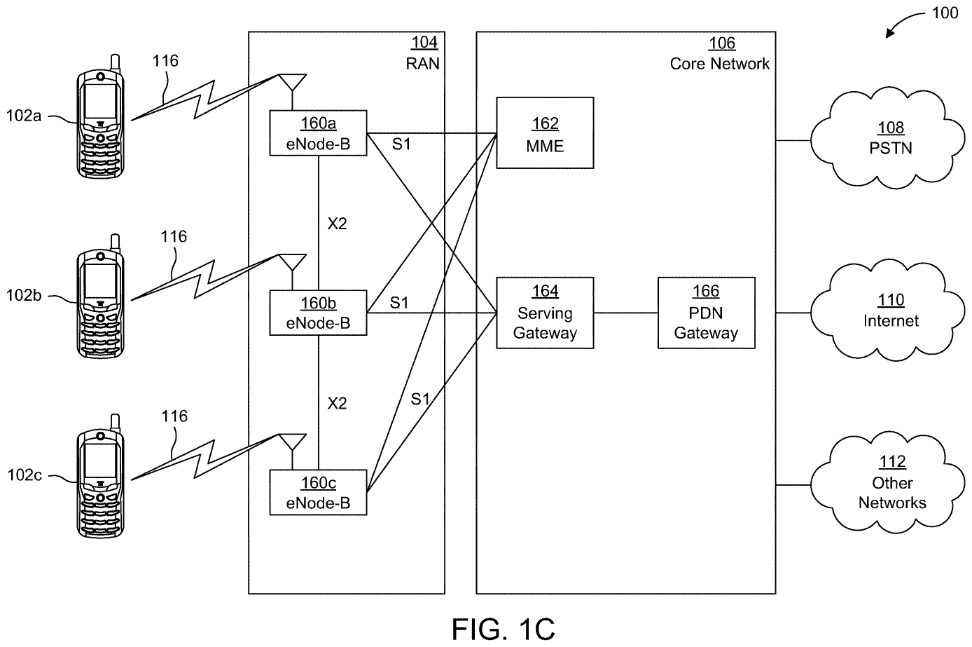

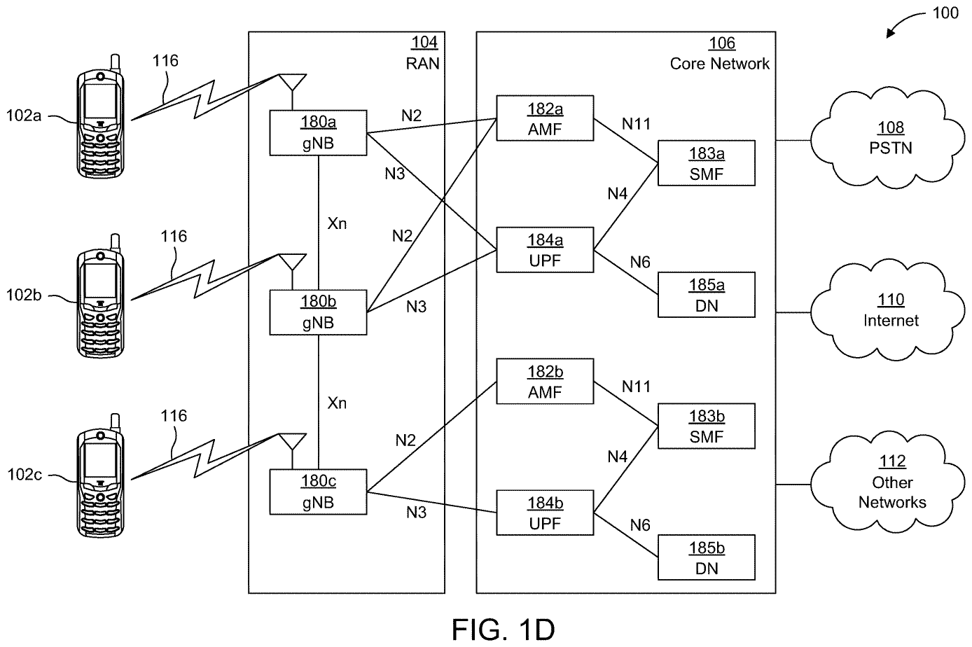

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

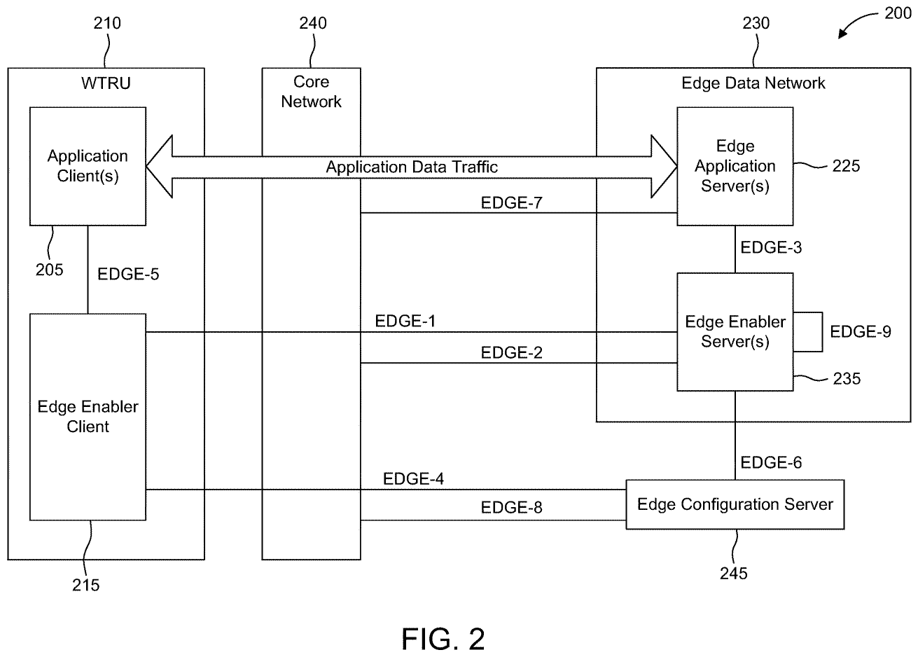

Described below are examples that provide enhancements to the 3GPP Edge Enablement Architecture. By way of example, FIG. 2 illustrates the SA6 architecture 200 via the high-level architecture. Specifically, FIG. 2 illustrates the SA6 Architecture 200 for enabling edge applications. Architecture 200 include a WTRU 210, which may include a single WTRU as illustrated for the readers convenience, or WTRU 210 may be one or more WTRUs. Architecture 200 includes a core network 240 and an edge data network 230. The components of the SA6 Architecture are described in more detail below.

WTRU 210 may include an Application Client (AC) 205. AC 205 may be a user application residing on WTRU 210. As used herein, AC 205 may be an application that communicates with an Edge Application Server (EAS) 225 within the edge data network 230. Cardinality is a function that WTRU 210 may use several AC 205 concurrently.

WTRU 210 may also include an Edge Enabler Client (EEC) 215. EEC 215 may provide edge support to one or more AC 205 instances on WTRU 210. Cardinality is a function that one or more EEC 215 per WTRU 210 and one AC 205 uses one EEC 215.

An Edge Configuration Server (ECS) 245 may provide supporting functions needed for EEC 215 or Edge Enabler Server (EES) 235 to discover EES 235 instances providing certain EAS 225. Cardinality is a function that one or more ECS 245 may be provided for network 240.

EES 235 may provide supporting functions needed for EAS 225 and EEC 215. In the context of a mobility/relocation use case, the Source-EES (S-EES) is EES 235 used before mobility/relocation happens and the Target-EES (T-EES) is EES 235 used after mobility/relocation has happened. Cardinality is a function that there is one or more EES 235 instance(s) per EDN 230 or DNN (Data Network Name) and there may be multiple EDN 230 instances or DNN in network 240. DNN is the name of EDN 230, for example, and a DNN may be assigned to EDN 230.

EAS 225 may provide an application server resident in EDN 230. EAS 225 may be software server providing a service to AC 205. In the context of a mobility/relocation use case, the Source-EAS (S-EAS) is EAS 225 used before mobility/relocation happens and the Target-EAS (T-EAS) is EAS 225 used after mobility/relocation has happened. Cardinality is a function that there are multiple EAS 225 instances in per EDN 230 or DNN—each EDN 230 or DNN may contain a different set of EAS 225 instances; some EAS 225 may serve a group of AC 205 instances that may be distributed on different WTRU 210 while some may exclusively serve a single AC 205 located on a single WTRU 210.

Application data traffic may flow between the application client 205 of WTRU 210 and edge application server 225 of edge data network 230. Reference points are shown as interfaces connecting various functional elements of the edge architecture. For example, EDGE-1 may be an interface between edge enabler client 215 and edge enabler server 235. EDGE-2 may be an interface between core network 240 and edge enabler server 235. EDGE-3 may be an interface between edge application server 225 and edge enabler server 235. EDGE-4 may be an interface between edge enabler client 215 and edge configuration server 245. EDGE-5 may be an interface between application client 205 and edge enabler client 215. EDGE-6 may be an interface between edge enabler server 235 and edge configuration server 245. EDGE-7 may be an interface between core network 240 and edge application server 225. EDGE-8 may be an interface between core network 240 and edge configuration server 245. EDGE-9 may be an interface between edge enabler servers 235 to allow different edge enabler servers 235 to communicate with each other.

Mobile devices may share internet connectivity via the mobile hot-spot functionality. The hot-spot functionality may allow a mobile device to expose itself as a Wi-Fi hot-spot where other devices can connect and share the internet connectivity provided by the mobile user's subscription. This functionality may expand to edge computing services as it becomes widely available in the mobile network; as such, a mobile device may be able to share both its internet connectivity, and additionally share connectivity to the edge infrastructure and share access to edge services according to the user's subscription. Other wireless and wired implementations, such as Bluetooth, ProSe, USB or Ethernet allow mobile connection sharing and may be used for edge computing services sharing.

The examples included herein provide methods for a cellular mobile device with a subscription to edge computing services to share such edge computing services with other devices connecting over a local connection. As used herein, the term “share” may mean “enable access to.”

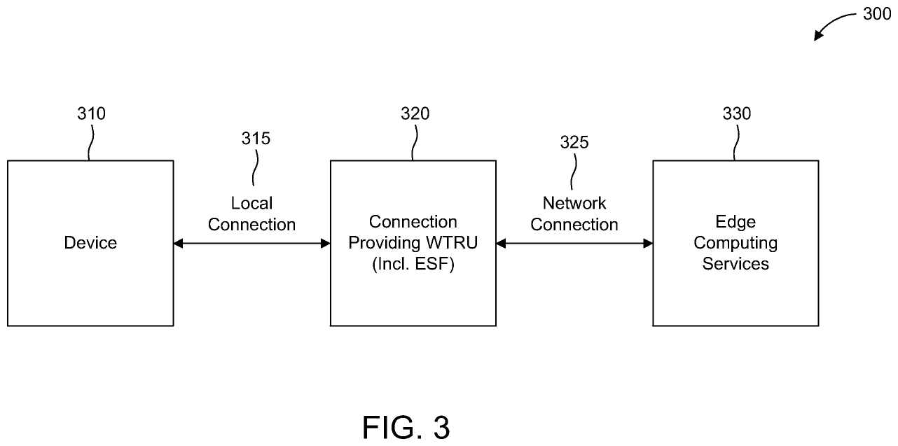

FIG. 3 illustrates an illustration 300 of edge sharing. Illustration 300 illustrates a device 310 that represents a device to be enabled with the edge sharing services. Device 310 may be connected via a local connection 315 to a connection providing WTRU 320. Connection providing WTRU 320 may include an edge sharing function and offer an edge sharing service. Connection providing WTRU 320 may be connected to edge computing services 330 via a network connection 325. Edge computing services may be of the form EDN 230 from FIG. 2. Within this framework methods are defined that enable edge sharing. An Edge Sharing Service (ESS) is offered by an Edge Sharing Function (ESF) via connection providing WTRU 320. Connection providing WTRU 320 may be a cellular mobile phone; through local connection 315. The ESF may enable the sharing of access to edge services 330 available in network connection 325 as illustrated in FIG. 3. Specifically, FIG. 3 illustrates an ESS high-level overview. The methods to enable an ESF to provide an ESS are described in detail below. The methods include provisioning an ESF, provisioning an ESS, registering to an ESS, implicit usage of EC services via DNS for ESS unaware devices and interacting explicitly with the EEL through an ESS.

As described herein, an ESF may be provisioned. As described herein, methods include a “connectivity provider WTRU” (cp-WTRU) 320 with an ESF configured to offer an ESS to locally connected devices. Additionally, a new service may be offered so that locally connected devices are automatically allowed to access to a particular edge service. For example, contrary to current behavior in known systems, where, if the operator allows traffic from locally connected devices (e.g., laptops, wearables, mobile phones) to gain access to internet services using either wired (e.g., through an ethernet cable, USB) or wireless (Bluetooth, Wi-Fi, ProSe) connectivity. Edge-Service access via a local connection may be enabled through new enhancements to access technologies, e.g., enhancements to Bluetooth and Wi-Fi technology, and data session establishment, using methods described below.

Examples of cp-WTRUs 320 may include a cellular mobile phone offering a local connection to nearby devices, a connected vehicle offering a local connectivity to passenger's devices or to nearby connected vehicles, and a mobile customer premises equipment (CPE) that offers local connectivity to nearby devices. Further, a CPE may be realized as a 5G Residential Gateway (5G-RG) or evolved Residential Gateway (eRG) in a Customer Premise Network (CPN). Examples of nearby devices that are locally connected may include cellular mobile phone, wearable devices, tablets, etc. Examples of an ESF may include software or hardware that is located on a cp-WTRU 320 with the purpose of sharing edge services available in an edge data network, a standalone software program or device driver that is executing on the cp-WTRU 320, and functionality integrated within an existing function such as an EEC present on a cp-WTRU 320. Examples of an ESS may include the functionality offered by an ESF, the communication endpoints offered to a client device for interacting with the ESF, and the data structure that are exchanged with a client device for interacting with the ESF. The cp-WTRU 320 may determine that it is allowed to offer an ESS based on an ESF configuration which can be pre-configured on the cp-WTRU 320, received from the network 325, or provided by a user via a user interface. A combination of the aforementioned alternatives is possible for configuring the cp-WTRU 320 for edge sharing.

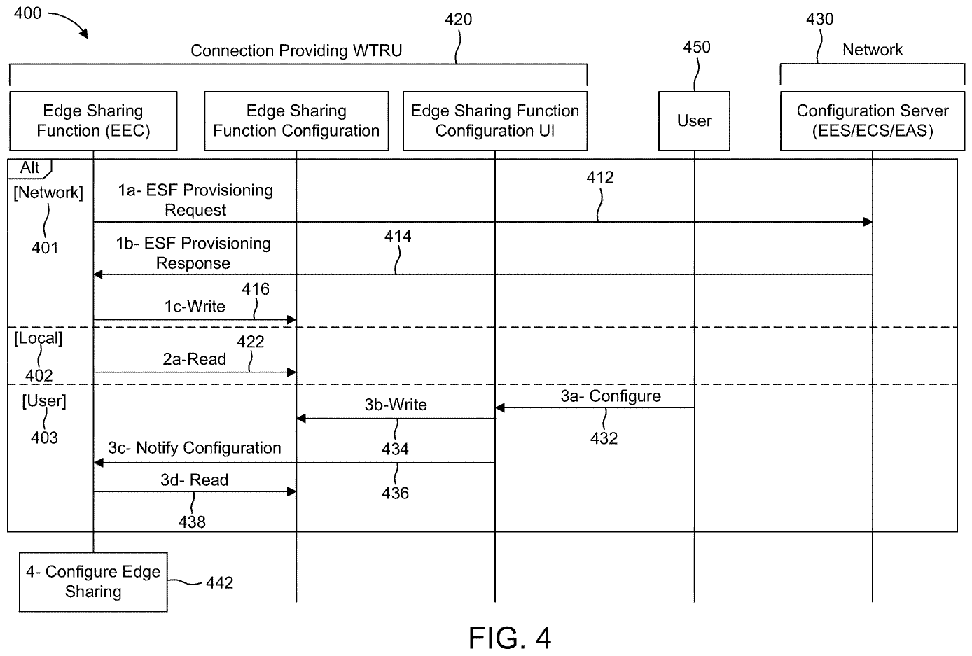

FIG. 4 illustrates a signaling diagram 400 illustrating example alternatives for provisioning an ESF. As shown in FIG. 4, the device, such as device 310 of FIG. 3, for example, may be configured. While not mutually exclusive, three possibilities or alternatives are provided. These possibilities include a network configuration 401, a locally configured configuration 402, and a user configuration 403. As illustrated, the configurations 401, 402, 403 include a CP WTRU 420 that may include an EEC with an ESF including an ESF configuration and ESF configuration user interface (UI), for example, a network 430 that may include a configuration server with an EES/ECS/EAS, as described above, for example, and a user 450.

In the network configuration 401, the provisioning of an ESF may include the cp-WTRU sending an ESF provisioning request 412 from cp-WTRU 420 via EEC to the network 430 configuration server. At 412, the ESF provisioning request may include the ESF of cp-WTRU 420 may send an ESF provisioning request 412 to a configuration server located in the network 430 to get edge sharing capabilities. The configuration server may be a standalone server or may be an existing server such as an EES, ECS or EAS. At 414, the configuration server of network 430 returns the ESF configuration response upon receiving the request 412. The ESF of cp-WTRU 420 may write the ESF configuration locally at 416 for future usage. The configuration server address of network 430 may be received from the mobile core network, obtained from a local configuration, or configured by a user interface. For example, the server address (e.g., FQDN or IP Address) may be received in the PCO information element of the PDU Session Establishment Accept Message or a PDU Session Modification Command.

In the local configuration 402, an alternative for provisioning an ESF may be made by reading a local ESF configuration 422. The ESF of cp-WTRU 420 may read the ESF configuration locally from the ESF configuration stored on cp-WTRU 420. For example, an EEC of cp-WTRU 420, which contains ESF functionality, may read an ESF configuration file located in non-volatile memory or located on a SIM card of cp-WTRU 420.

In the user configured configuration 403, an alternative for provisioning an ESF may be a user manually providing the ESF configuration. User 450 may provide the ESF configuration via an ESF configuration UI of cp-WTRU 420 at 432, for example, in the same manner that a user configures a local connection. The ESF configuration UI may in turn write the ESF configuration 434 locally for future use and may notify the ESF 436 that an ESF configuration is available. Upon receiving the ESF configuration notification, the ESF can read 438 the ESF configuration.

At 442, the ESF of cp-WTRU 420 may apply the ESF configuration previously obtained via at least one of network 401, locally 402, and user configured 403, and may offer the ESS according to the parameters of the ESF configuration. The ESF configuration may include conditions that may be fulfilled to allow cp-WTRU 420 to offer edge sharing. For example, PLMN identifier(s) may indicate if edge sharing is allowed, a geographical area indicating where edge sharing is allowed, a network topological area indicating that edge sharing is allowed when connected to certain access points, a time period indicating when edge sharing is allowed, an ECSP identifier indicating which edge computing service provider allow edge sharing or an EDN identifier indicating which edge data network(s) allow edge sharing. The ESF may determine to not enable edge sharing when the above conditions are not met, in certain configurations.

The ESF configuration may include the identities of services that the ESF may share or use in the context of the ESS. For example, the ESF configuration may include a list or combination of edge application servers' identities (EASID, EAS endpoint, URL, FQDN, IP address), edge enabler servers' identities (EESID, EES endpoint, URL, FQDN, IP address), edge configuration servers' identities (URL, FQDN, IP address, ECS provider identifier). The ESF configuration may include the identities of applications or devices that the ESF may serve edge services to. For example, the ESF configuration may include a list of application client identifiers (ACID, AC Type). For example, the ESF configuration may include the identities of devices that the ESF may provide the sharing service to.

In order to provision the ESS, an ESF may indicate its edge sharing capabilities, and a nearby device may discover ESF capabilities and methods by which the nearby device is provisioned with an ESS configuration are described. A device may use an ESS configuration to learn about the ESF capabilities and access edge services offered through the ESF. The ESS configuration may include a registration endpoint that may be used by the device to register to the ESF prior to using shared edge services, a discovery endpoint that may be used by the device to discover available services offered through the ESF, service identifiers, such as edge application server identities (EASID, EAS endpoint, URL, FQDN, IP address), that indicate to the device what services can be accessed via the ESF, and application client identifiers, such as application clients (ACID, AC Type), that indicate what applications can be served via the ESF. Additionally, the ESF may include in the ESS any of the parameters present in the ESF configuration previously mentioned. For example, the ESS configuration may include a PLMN identifier, a geographical area, a network topological area, a time period, an ECSP identifier, an EDN identifier.

Methods for ESS provisioning may include non-advertised ESS provisioning and advertised ESS provisioning. For example in non-advertised ESS provisioning, in certain applications, the ESF may not advertise edge sharing capabilities. The device may first connect to the cp-WTRU via the local connection before it discovers if edge sharing is offered. The device may learn if edge sharing is offered and obtains the ESS configuration using one or more of the following methods. The device may receive the ESS configuration in a new DHCP option sent from the cp-WTRU as part of the procedure for providing IP configuration to the device. The device may send a request message to the ESF present on a cp-WTRU to obtain the ESS configuration. The device may receive a notification message or broadcast message from the ESF present on cp-WTRU containing the ESS configuration.

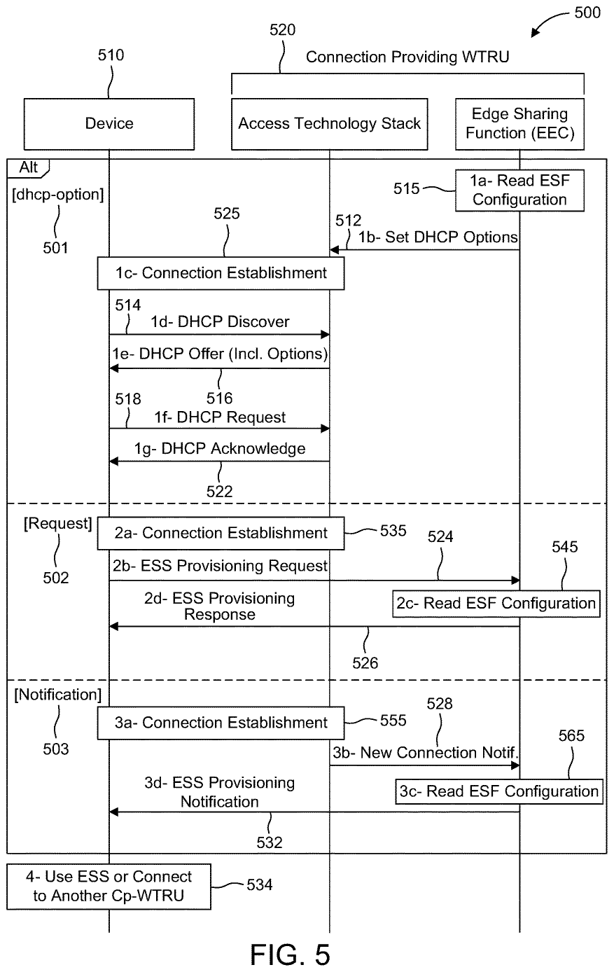

FIG. 5 illustrates a signaling diagram 500 illustrating alternatives for non-advertised ESS provisioning. FIG. 5 illustrates a scenario for configuring the device 510 (such as device 310 of FIG. 3) with cp-WTRU 520 before the edge sharing occurs. Specifically, the alternative, while not necessarily mutually exclusive, provide an alternatives for a device that does not have access to discover for sharing. The alternatives include DHCP options 501, request options 502, and notification options 503. The description of FIG. 5 assumes that the ESF is provisioned, and that the cp-WTRU 520 offers a local connection.

For DHCP option 501, at 515, an ESF configuration is received, the ESF may read the ESF configuration and accordingly establish an ESS configuration. The ESF may set new DHCP options related to the edge sharing service at 512. The new DHCP options may include information indicating that cp-WTRU 520 offers an ESS, and information regarding accessing the ESS, information to obtain the ESS configuration or an ESF configuration. The DHCP options may be provided via a DHCP configuration API or via a DHCP configuration file depending on the DHCP implementation. This DHCP configuration may be performed prior to offering the local connection. Subsequently, device 510 may establish a local connection at 525 with cp-WTRU 520 and may send a DHCP discover message at 514 to obtain its IP configuration. The DHCP server may return a DHCP offer message at 516 to device 510. The DHCP offer message at 516 may contain ESS DHCP option which may include the ESS information mentioned at 512. Upon accepting the DHCP lease offer, device 510 may send a DHCP request message at 518 to the DHCP server, and the DHCP server may return a DHCP acknowledge at 522 to device 510.

For request configuration option 502, a second alternative for performing a non-advertised ESS provisioning may occur by sending an ESS provisioning request to the ESF. Device 510 establishes a connection to the cp-WTRU 520 at 535. Once the connection is established, device 510 may send an ESS provisioning request at 524 to the ESF. For example, the request may be sent to the default gateway provided in the DHCP offer message, or alternatively may be sent to an address provided in the DHCP options. The request at 524 may be routed to the ESF function. Upon reception of the ESS provisioning request at 524, the ESF may read the ESF configuration at 545 and accordingly establish an ESS configuration. The ESF may return the ESS configuration in an ESS provisioning response at 526.

For notification option 503, a third alternative for performing a non-advertised ESS provisioning may occur by sending an ESS provisioning notification of broadcast message to device 510. Device 510 establishes a connection to cp-WTRU520 at 555. Once the connection is established at 555, the ESF may be notified of the new connection at 528 and may read the ESF configuration at 565 to establish an ESS configuration. The ESF may send an ESS provisioning notification at 532 to device 510. For example, the provisioning notification may be sent using the leased IP address that may have been learned at 528, or alternatively by sending a broadcast message. Although not illustrated, device 510 may need to subscribe to receive notifications, may be automatically subscribed at connection establishment or may need to listen for broadcast messages.

At 534, device 510 may use the obtained ESS configuration (obtained via DHCP option 501, request option 502, notification option 503) to decide if the local connection should be used. For example, device 510 may choose to connect to a different cp-WTRU 520 if edge sharing is not offered, or if the ESS configuration does not fulfill the edge requirements of the device.

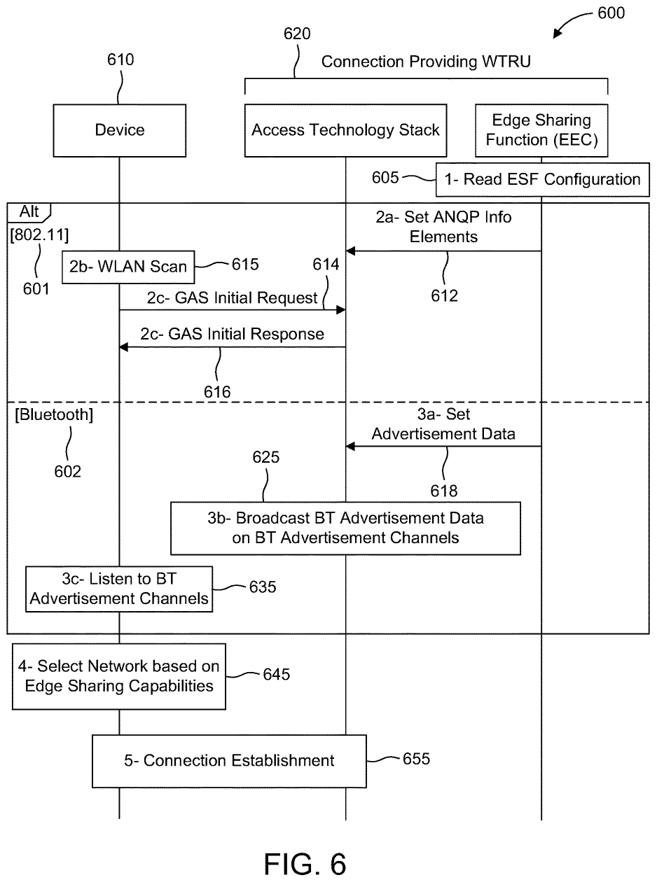

FIG. 6 illustrates advertised provisioning alternatives 600. The advertised provisions alternatives 600 as similar to connecting with the non-advertised provisions 500 of FIG. 5. For example, device 600 may use wireless technology to connect in 802.11 option 601 or select a connection network via Bluetooth 602. In certain applications, the ESF may advertise edge sharing capabilities; device 610 may learn that edge sharing is offered before connecting to cp-WTRU 620. Device 610 may obtain the ESS configuration as part of the advertisement mechanism or alternatively after connecting to cp-WTRU 620 as previously described. The ESF may advertise edge sharing support. For example, cp-WTRU 620 may provide Access Network Query Protocol (ANQP) information element(s) to device 610 when using a Wi-Fi local connection via 802.11 option 601. Device 610 may query cp-WTRU 620 using the ANQP protocol. The ANQP information elements may contain edge sharing capability and the ESS configuration. For example, cp-WTRU 620 may provide a Bluetooth Advertisement on the Bluetooth advertisement channel(s) when using Bluetooth local connection via option 602. Device 610 may learn edge sharing capability from the advertisement packet, or alternatively from the additional data obtained by performing a Bluetooth scan request. The advertisement data may provide the ESS configuration.

FIG. 6 illustrates alternatives for advertised ESS provisioning. The description of FIG. 6 assumes that the ESF is provisioned and that cp-WTRU 620 offers a local connection. At 605, the ESF may read the ESF configuration and accordingly establish an ESS configuration.

In the 802.11 option 601, a first alternative for performing an advertised ESS provisioning may be using new ANQP information elements when using a Wi-Fi local connection. The ESF may configure ANQP information elements at 612 based on the ESS configuration established at 605. For example, the new ANQP information elements may include information indicating that cp-WTRU 620 offers an ESS, information on how to access the ESS, information on how to obtain the ESS configuration or an ESF configuration. Device 610 may perform a wireless LAN scan and discover cp-WTRU 620 network at 615. Device 610 may issue a GAS initial request at 614 to enquire about the capability of the network offered by cp-WTRU 620. cp-WTRU 620 may return a GAS initial response at 616 to device 610 that may include the newly defined ANQP information elements previously defined, indicating edge sharing capabilities at cp-WTRU 620.

In the Bluetooth option 602, a second alternative for performing an advertised ESS provisioning may be using Bluetooth advertisements when using Bluetooth local connection. The ESF may configure advertisement information at 618 based on the ESS configuration established in at 605. The Bluetooth stack may advertise the edge capabilities and ESS configuration on the Bluetooth advertisement channels at 625 to make the information available for device 610. Device 610 may listen to the Bluetooth advertisement channel to obtain the edge sharing capability and the ESS configuration at 635. In certain implementations, device 610 may obtain edge sharing capability and the ESS configuration by performing a Bluetooth scan request to obtain additional data.

At 645, device 610 may use the edge sharing capability and the ESS configuration advertised by the cp-WTRU(s) 620 to select a local network that meets the device edge requirements. The Edge sharing capability may be advertised as a specific S-NSSAI. The devices 610 may be configured to understand and associate the S-NSSAI information (SST or SD) to a particular ESS. At 655, device 610 may establish a connection to the local network selected in at 645.

Registering to an edge sharing service may be used including methods by which a device can register to an ESS for the purpose of discovering and using edge services. A device, such as the devices that are now connected to the network based on FIGS. 5 and 6, may need to register with the ESF prior to using the ESS. The registration may be needed to authorize a device to use an ESS and to authorize the device to access particular edge services. The ESF may use the registration request to learn information about a device, may use the registration to locally establish a device context for the device and may provide supplemental information back to the device via a registration response message. Additionally, registration of the device with the ESF may trigger a series of optional interactions between the ESF and the network, such as service provisioning, EES selection, EEC registration, EAS discovery, and EAS selection.

In certain deployments, the ESF may use information provided in a device registration request to inform participants of an edge enablement layer (EEL), such as the ECS, the EES or the EAS, that certain transactions are performed on behalf of a local device. This information may influence how EEL participants handle and respond to such requests performed on behalf of a local device.

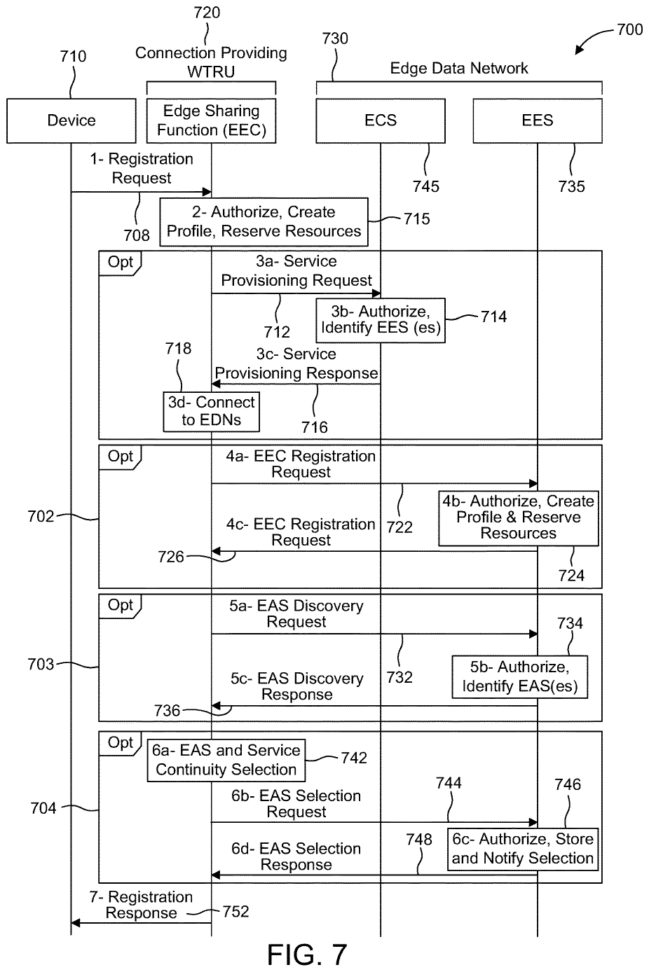

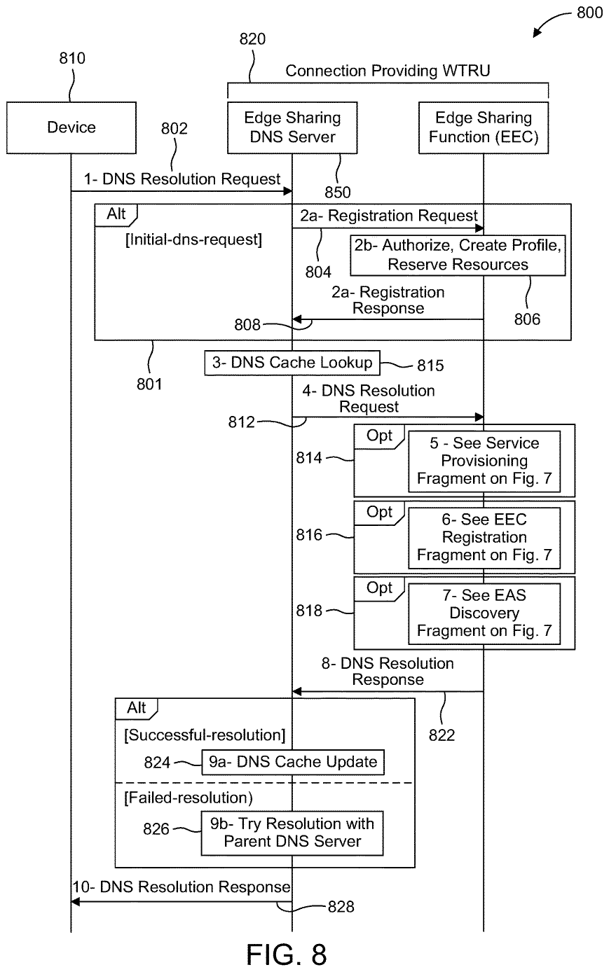

FIG. 7 illustrates the explicit registration 700 of a device to an ESF. In FIG. 7, the ESF is implemented in the EEC and both terms can be used interchangeably. The description of FIG. 7 assumes that device 710 has established a local connection to cp-WTRU 720 and the ESS is provisioned in device 710 as is described in the figures above. The methods described below for registering local device 710 to the ESF may include an explicit registration 700 performed by an edge-aware device or an implicit registration (800 of FIG. 8) performed by an edge-unaware device. Explicit registration for edge-aware devices may be used as described with respect to FIG. 7. In certain applications, device 710 may be edge-aware and may explicitly send a registration request to the ESF prior to using the ESS. The registration request may be sent to a well-known endpoint or IP port on cp-WTRU 720, may be sent to the default gateway associated with cp-WTRU 720, may be sent to an endpoint provided in the ESS configuration, or any combination of the above.

At 708, device 710 may send a registration request to cp-WTRU 720. The registration request may be based on information contained in the ESS configuration. The registration request may contain information about device 710. For example, the information may include an identifier that uniquely identifies device 710 and that may allow the ESF to differentiate different devices concurrently using the ESS. The identifier may contain, or be used to derive, the identity of a server that can be used to authenticate and authorize device 710. For example, the information may include security credentials that allow device 710 to use the ESS. The security credentials may allow the ESF to authorize device 710 to access the ESS or the edge services offered through the ESS. For example, the information may include application client information that provides information about applications located on device 710. The application client information may allow the ESF to determine at registration time if the network can provide the necessary EAS support the application clients. For example, the information may include EAS information about the edge application servers that device 710 may require (i.e., the services that device 710 needs to access). For example, the information may include capabilities of device 710 to support service continuity. The ESF may use this information to find edge resources that are compatible with the supported service continuity. For example, the information may include a device profile that may provide contextual information to the ESF on how to perform certain operations with the edge network 730.

In a first example, the device profile may indicate that the device is a temporary device (for example, a nearby user in a restaurant, a nearby V2V connection, etc.). Based on the device profile, the ESF may for example choose not offer or not to trigger service continuity when moving away, or may for example send indication to the device that it is moving away, or may for example provide to the device limited edge services.

In a second example, the device profile may indicate that the device is a permanent device (for example, a VR headset, a passenger in a vehicle, etc.). Based on the device profile, the ESF may decide for example to trigger service continuity for the device based on its own service continuity determination or may for example provide a higher level of edge services.

At 715, upon receiving the registration request, the ESF/EEC of cp-WT RU 720 may validate if device 710 is authorized to use the ESS, may create a profile for storing the registering device information, and may reserve local resources for the registering device. This element may involve contacting a server to authenticate and authorize the device.

While the remainder of the description of FIG. 7 includes multiple alternatives, these are described as alternatives to provide a delineation between. However, it is possible, and likely, that more than one alternative may be performed, and in fact all of the alternatives may be used.

In a first alternative 701, the ESF/EEC of cp-WTRU 720 may send a provisioning request at 712 to an ECS 745 of the edge data network 730, indicating that the provisioning procedure is made on behalf of device 710. For example, the service provisioning request at 712 sent to the ECS 745 may include edge sharing information that may include an edge sharing user identifier or an edge sharing device identifier. This information may influence the list of EES instances provided by the ECS in the provisioning response at 718. Other interactions related to service provisioning, such as subscription, notification and subscription management may include the edge sharing information and be influenced by the edge sharing information.

At 712, in certain deployments, the ESF/EEC of cp-WTRU 720 may perform a provisioning procedure with the ECS on behalf of device 710. The ESF may send a provisioning request at 712 to ECS 745 and may include in the provisioning request the EECID that uniquely identifies the ESF/EEC of cp-WTRU 720, the security credentials that authorize the ESF/EEC of cp-WTRU 720 to use the ECS service, the device application client profiles that are used to identify EESs offering matching EAS, device 710 and ESF/EEC service continuity support that is used to identify EESs offering matching service continuity capabilities, the WTRU identifier (GPSI or identity token) of cp-WTRU 720, the connectivity information of cp-WTRU 720, the WTRU location of cp-WTRU 720, the device profile that may be used to determine if EES is allowed to offer services to devices.

Upon receiving the provisioning request, at 714, ECS 745 may verify if the ESF/EEC of cp-WTRU 720 is authorized to perform service provisioning and identifies EES instances using the information provided in the provisioning request. If the request processing is successful at 714, at 716, ECS 745 returns a service provisioning response that contains the connectivity information (EDN) and a list of EES instances that can provide edge services to device 710. If the request processing is unsuccessful at 714, ECS 745 may return a failure and a reason it was unable to fulfill the service provisioning request at 712. If a successful service provisioning response is received at 716, at 718 the ESF/EEC of cp-WTRU 720 may trigger establishment of a PDU sessions to EDNs included in the response if required and may create traffic steering rules (e.g., WTRU local configuration) or may use URSP rules configured by the network to reach the selected EES instances(s). The PDU session establishment may also happen as a result of the ESF/EEC attempting to access an EES instance, for example to register or perform EAS discovery. The service provisioning procedure may not be performed if the ESF/EEC has local information (e.g., cached information) about EES instances capable of fulfilling the device requirements.

In a second alternative 702, the ESF/EEC of cp-WTRU 720 may register to EES 735, indicating that the registration is made on behalf of device 710. For example, the registration request at 722 sent to the EES 735 may include edge sharing information that may include an edge sharing user identifier or an edge sharing device identifier. This may influence how EES 735 manages the device context, either as a separate device context or a sub-context of the ESF/EEC of cp-WTRU 720. Additionally, EES 735 may issue specific registration identifier, expiry time or EEC context id that may be different to the ones issued for cp-WTRU 720. Other interactions related to ESF/EEC registration, such as registration management may include the edge sharing information and be influenced by the edge sharing information.

At 722, in certain deployments, the ESF/EEC of cp-WTRU 720 may perform an EEC registration procedure with the EES 735 instance(s) on behalf of device 710. The ESF/EEC of cp-WTRU 720 may send a registration request to the EES 735 instance(s) and may include in the registration request the EECID that uniquely identifies the ESF/EEC, the WTRU identifier (GPSI or identity token) of cp-WTRU 720, the security credentials that authorize the ESF/EEC to use the EES service, the device application client profiles for which edge services are provided, device 710 and ESF/EEC service continuity support that is used to identify EASs offering matching service continuity capabilities, the device profile that may be used to determine EAS allowed to offer services to devices.

Upon receiving the EEC registration request, at 724, EES 735 may verify if the ESF/EEC is authorized to perform EEC registration, and if EES 735 may fulfill the requirements of the AC profiles, EES 735 may reserve resources for the registering device. If the request processing is successful, at 726, EES 735 may return an EEC registration response which may include a registration identifier and may include a context identifier; the registration and context identifier for device 710 may be different than the ones assigned to cp-WTRU 720. EES 735 may return a failure and a reason if it was unable to fulfill the ESF/EEC registration request. In certain deployments, EEC registration to EES 735 may not be required.

In a third alternative 703, the ESF/EEC of cp-WTRU 720 may send an EAS discovery request at 732 to EES 735, indicating that the discovery request is made on behalf of device 710. For example, the EAS discovery request at 732 sent to EES 735 may include edge sharing information that may include an edge sharing user identifier or an edge sharing device identifier. This may influence the list of EAS instances provided by EES 735 in the EAS discovery response at 736. Other interactions related to EAS discovery, such as subscription, notification and subscription management may include the edge sharing information and be influenced by the edge sharing information.

At 732, the ESF/EEC of cp-WTRU 720 may perform an EAS discovery procedure with the EES instance(s) on behalf of device 710. The ESF/EEC may send an EAS discovery request at 732 to EES 735 instances and may include in the discovery request the EECID that uniquely identifies the ESF/EEC, the WTRU identifier (GPSI or identity token) of cp-WTRU 720, the security credentials that authorize the ESF/EEC to use the EES service, device 710 EAS information that may be used to identify EAS instances, the WTRU location of cp-WTRU 720, the device and ESF/EEC service continuity support that is used to identify EAS instances offering matching service continuity capabilities.

Upon receiving the EAS discovery request, at 734, EES 735 may verify if the ESF/EEC of cp-WTRU 720 is authorized to perform EAS discovery and may identify EAS instance(s) using the information provided in the provisioning request. If the request processing is successful, at 736, EES 735 returns an EAS discovery response that contains the EAS instance(s) endpoints that can be used by device 710. If the request processing is unsuccessful, EES 735 may return a failure and reason it was unable to fulfill the EAS discovery request. The EAS discovery procedure may not be performed if the ESF/EEC has local information (e.g. cached information) about EAS instances capable of fulfilling the device requirements.

In a fourth alternative 704, ESF/EEC of cp-WTRU 720 may send an EAS selection request at 744 to EES 735, indicating which EAS instance and which service continuity methods have been selected. For example, the EAS selection request at 744 sent to EES 735 may include edge sharing information that may include an edge sharing user identifier or an edge sharing device identifier. This request may be used by EES 735 to store the ESF/EEC selection for future use and may be used to inform the EAS of selection and service continuity methods.

At 742, the ESF/EEC of cp-WTRU 720 may perform an EAS selection based on the discovered EAS instance(s) on behalf of device 710. The ESF may also perform a selection of the service continuity method(s) to be used for each of the EAS instance(s) selected for device 710. Additionally, the ESF/EEC may create traffic steering rules (e.g. WTRU local configuration), or may use URSP rules configured by the network to allow the device traffic to reach the selected EAS instance(s). The ESF/EEC may send an EAS selection request at 744 to EES 735 instance(s) and may include in the selection request the EECID that uniquely identifies the ESF/EEC, the WTRU identifier (GPSI or identity token) of cp-WTRU 720, the security credentials that authorize the ESF/EEC to use the EES service, the selected EAS instance information, the selected service continuity method for each selected EAS.

Upon receiving the EAS selection request at 744, at 746, EES 735 may verify if the ESF/EEC is authorized to perform EAS selection, may store the EAS instance(s) selection and service continuity methods, and may inform the selected EAS instance(s) of selection and of service continuity methods. If the request processing at 746 is successful, at 748, EES 735 may return an EAS selection response that acknowledges EAS selection and service continuity method. If the request processing at 746 is unsuccessful, EES 735 may return a failure and reason it was unable to acknowledge the EAS selection request. In certain deployments, EAS selection request sent to the EES may not be required.

In a fifth alternative (not shown), the ESF/EEC, ECS, EES and EAS may use the local device registration information when performing service continuity procedures, considering that the local device is co-located with the cp-WTRU. This may influence the EAS context relocation and EEC context relocation of applications associated with the cp-WTRU and the local device.

FIG. 8 illustrates the implicit registration 800 of a device. Implicit registration for edge-unaware devices may be used. In certain applications, device 810 may be edge-unaware and may still get transparently registered to the ESF. Transparent registration assumes that device 810 has no knowledge of the edge communication protocols and relies on DNS messaging. In this scenario, most of the edge related operations and decisions are offloaded to the ESF. A DNS server is executing on cp-WTRU 820 and this DNS server is the one provided to device 810 when the local connection is established (e.g., via DHCP or other method described above). In the implicit registration 800, the ESF is implemented in the EEC and both terms can be used interchangeably. The description of FIG. 8 assumes that the device has established a connection to cp-WTRU 820 and the ESS is provisioned in device 810.

At 802, device 810 may send a DNS resolution request to DNS server 850 of cp-WTRU 820 that has been configured for the local network. DNS server 850 may be a DNS server residing on cp-WTRU 820, may have been provided to the device in the DHCP configuration procedure described above and may be used for the purpose performing edge sharing with edge-unaware devices. The DNS resolution request may contain the URL of a server.

At 801, upon receiving the DNS resolution request of 802, edge sharing DNS server 850 verifies this is the first request received from device 810. If it is the first request, edge sharing DNS server 850 sends a registration request at 804 to the ESF/EEC of cp-WTRU 820, indicating the IP and MAC address of the device. At 806, the ESF/EEC may validate if device 810 is authorized to use the ESS. For example, the ESF/EEC may validate if the MAC address of device 810 has been authorized to use the edge sharing service. Further, the ESF/EEC may create a profile for storing the registering device information and may reserve local resources for the registering device. At 808, the ESF/EEC responds to the edge sharing DNS server 850. If the response of is deemed to be a success, edge sharing DNS server 850 proceeds to 815. If the registration failed, edge sharing DNS server 850 may proceed to 828.

At 815, edge sharing DNS server 850 may perform a DNS cache lookup to see if a resolution for the requested URL has already been performed. If a cache lookup match is found, edge sharing DNS server may proceed to 828.

At 812, edge sharing DNS server 850 may send a DNS resolution request to the ESF/EEC of cp-WTRU 820. This request may contain a URL to resolve.

At 814, the ESF/EEC of cp-WTRU 820 may perform the service provisioning procedure with the network as described in the service provisioning fragment 701 of FIG. 7.

At 816, the ESF/EEC of cp-WTRU 820 may perform the registration procedure with the network as described in the service provisioning fragment 702 of FIG. 7.

At 818, the ESF/EEC of cp-WTRU 820 may perform the EAS discovery procedure with the network as described in the service provisioning fragment 703 of FIG. 7.

At 822, the ESF/EEC of cp-WTRU 820 may send a DNS resolution response to the edge sharing DNS server 850. The ESF may have chosen one or more EAS and may include the IP address of such servers in the DNS resolution response.

At 824, if the DNS resolution was successful, edge sharing DNS server 850 may update the DNS cache with the IP records received in the DNS resolution response of 822. Otherwise, edge sharing DNS server 850 may try to resolve the URL using its parent DNS server at 826. The parent DNS server may be located within or outside the operator network and may result in resolving the URL to a cloud server.

At 828, edge sharing DNS server 850 may send a DNS resolution response to device 810. If the resolution is successful, the response at 828 may include records providing the IP address of EAS instance(s) or of cloud servers if no EAS was identified. If the resolution is unsuccessful, edge sharing server 850 responds at 828 with a DNS resolution failure.

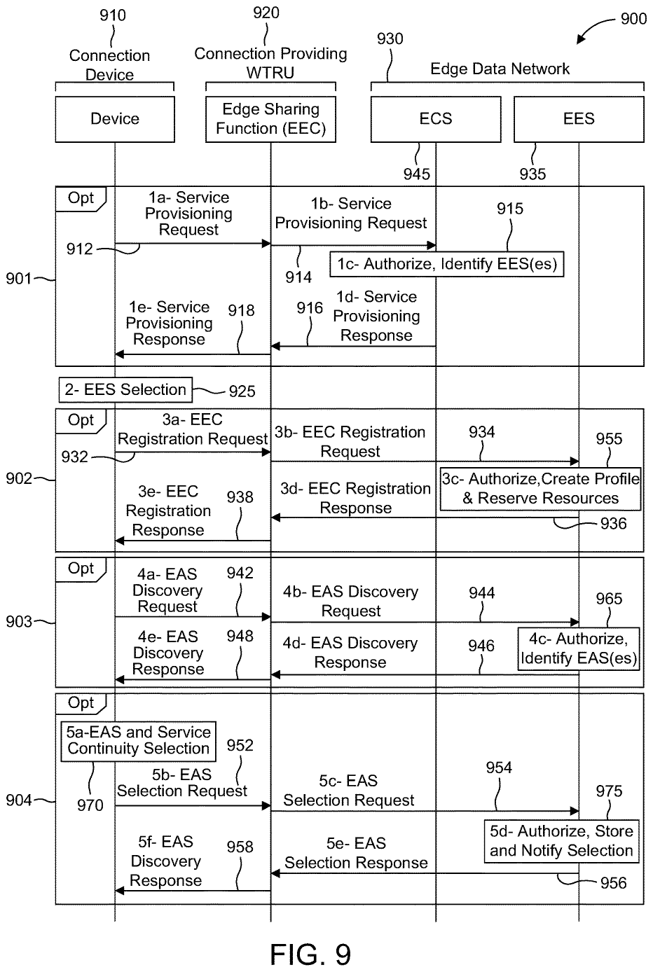

Interacting explicitly with the EEL through an edge sharing service may be used including alternative methods by which a device 910 that has edge enabler client (EEC) capabilities to explicitly perform edge service provisioning, EES selection, EEC registration, EAS discovery and EAS selection through an ESS. Methods allowing device 910 to explicitly register to an ESS 935 and implicitly obtaining EAS instances at registration time are included above. These methods offload the processing and decisions to ESF of cp-WTRU 920. Some devices may have more capabilities and may contain an implementation of an EEC which may benefit from a direct interaction with the network for discovering available EAS instance(s). FIG. 9 illustrates various alternatives 900 that device 910 with EEC capabilities can have through an ESS. The description of FIG. 9 assumes that the device established a local connection to cp-WTRU 920, the ESS is provisioned in device 910 as described above and device 910 is registered with the ESF as described above.

At 901, device 910 may send a service provisioning request at 912 to the ESF of cp-WTRU 920. The service provisioning request may be based on information contained in the ESS configuration. The service provisioning request may include the EECID that uniquely identifies the EEC of device 910, information identifying device 910 (GPSI or identity token), the security credentials that authorizes the EEC of device 910 to use the ESS, the device application client profiles that are used to identify EESs 935 offering matching EAS, the device EEC service continuity support that is used to identify EESs 935 offering matching service continuity capabilities, the location of device 910, and the device profile that may be used to determine EES 935 allowed to offer services to devices 910.

The EECID or GPSI may be encoded so that it can be resolved to point of contact that can be used to authenticate and authorize the EEC of device. For example, part of the EECID may identify a service provider that hosts a AAA Server that can be used to authenticate and authorize the EEC of device.

Upon receiving the service provisioning request of 912, the ESF of cp-WTRU 920 may locally verify if device 910 is authorized to perform service provisioning and may send a service provisioning request at 914 to ECS 945. The ESF of cp-WTRU 920 may perform service provisioning with ECS 945 on behalf of device 910, as described in the service provisioning fragment 701 of FIG. 7, or alternatively relay the device request directly to ECS 945. The ESF may use locally configured information to perform this local verification step. For example, the ESF may have been locally configured via a user interface with the identity of EECID or GPSIs that are authorized to perform service provisioning.

It should be appreciated, in 914, 915, 916, 918 ECS 945 may perform the service provisioning procedure if the ESF of device 920 and the device 910 EEC are authorized by ECS 945, and that EES 935 instance(s) returned may be used by the device 910 EEC.

At 925, device 910 may select one or more EES 935 instance(s) and may begin to generate traffic towards one or more of EES 935 instance(s). When cp-WTRU 920 receives a packet that is addressed to EES 935, cp-WTRU 920 may use a policy or rule to determine if an existing PDU Session or a new PDU Session should be used to send the packet towards EES 935 instance(s). Cp-WTRU 920 may use URSP rules to select an existing PDU or determine to establish a new PDU Session. For example, the Traffic Descriptor of a URSP Rule may be used to determine which URSP Rule applies. Alternatively, the WTRU may receive a URSP Rule whose traffic descriptor indicates that it applies to all devices.

Alternatively, the ESF of cp-WTRU 920 may use an EESID that is received from device 910 to determine a DNN/S-NSSAI combination to use or to use a traffic descriptor in URSP Rule evaluation. For example, the WTRU may use information that was received from ECS 945 to map the EESID to a traffic descriptor.

At 902, similar to 901, it should be appreciated, that device 910 EEC may send an EEC registration request 932 to the ESF of cp-WTRU 920. The ESF may locally verify if device 910 EEC is authorized to perform EEC registration. The ESF may perform EEC registration on behalf of the device or may relay the device request at 934 to EES 935. Registration of the device occurs at 955. In the event that EES 935 was the registrar, EES 935 sends an EEC registration response to the ESF of cp-WTRU 920 at 936. The ESF may send an EEC registration response 938 to device 910 EEC.

At 903, similar to 901, it should be appreciated, that device 910 EEC may send an EAS discovery request 942 to the ESF of cp-WTRU 920. The ESF may locally verify if the device EEC is authorized to perform EAS discovery. The ESF may perform EAS discovery on behalf of the device or may relay the discovery request at 944 to EES 935. Registration of the device occurs at 965. In the event that EES 935 was the registrar, EES 935 sends an EAS discovery response at 946 to the ESF of cp-WTRU 920. The ESF may send an EAS discovery response 948 to device 910 EEC.

At 904, device 910 may perform an EAS selection based on the discovered EAS instances at 970, may perform a service continuity method selection for each of the selected EAS instances. Similar to 901, it should be appreciated, that the device EEC may perform the EAS selection. An EAS selection request at 952 may be send from device 910 to ESF of cp-WTRU 920. The ESF of cp-WTRU 920 may locally verify if the device EEC is authorized to perform EAS selection. The ESF may perform EAS discovery on behalf of the device or may relay the device request at 954 to EES 935. Registration of the device occurs at 975. In the event that EES 935 was the registrar, EES 935 sends an EAS selection response at 956 to the ESF of cp-WTRU 920. The ESF may send an EAS discovery response 958 to device 910 EEC. If the EAS selection is successful, it should be appreciated, that device 910 may start generating traffic towards the selected EAS instance(s) which may result in steering of device 910 traffic towards the selected EAS instances.

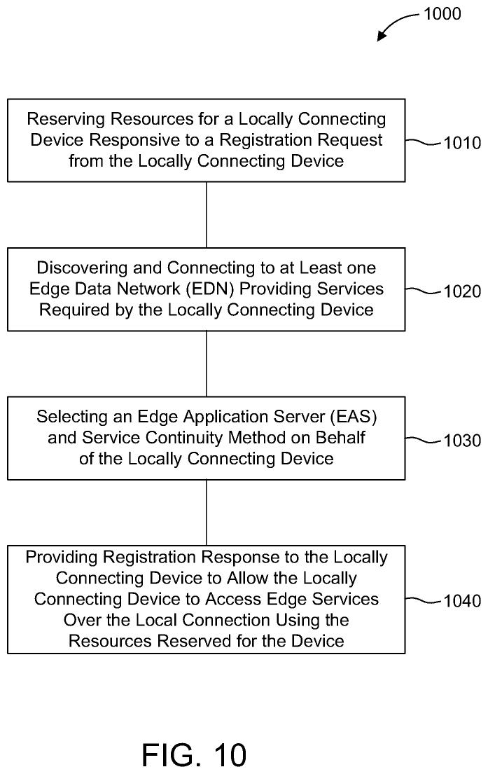

FIG. 10 illustrates a method 1000 performed in a wireless transmit receive unit (WTRU) for providing an Edge Sharing Service (ESS) via a local connection. Method 1000 includes at 1010 reserving resources for a locally connecting device responsive to a registration request from the locally connecting device. At 1020, method 1000 includes discovering and connecting to at least one edge data network (EDN) providing services required by the locally connecting device. At 1030, method 1000 includes selecting an edge application server (EAS) and service continuity method on behalf of the locally connecting device. At 1040, method 1000 includes providing registration response to the locally connecting device to allow the locally connecting device to access edge services over the local connection using the resources reserved for the device. Method 1000 may further include requesting Edge Sharing Function (ESF) via an edge enabler client (EEC) registration and receiving an EEC response. The EEC response may include connectivity information allowing the locally connecting device to access a service provided by the selected edge application server. Method 1000 may further include authenticating and authorizing the device to access edge services. Method 1000 may further include discovering edge services on behalf of the locally connecting device. Method 1000 may further include providing the locally connecting device with an address of a selected EAS. Method 1000 may further include configuring the required connectivity for the locally connecting device to access the EAS. The resources reserved for the device may include at least one of processing, memory and the configuration needed to keep the registration alive. The resources reserved for the device may enable discovery of the EDN/EAS, enable that the locally connecting device traffic is sent to the proper EDN/EAS, and enable service continuity. The service continuity may include connectivity with the EDN/EAS managed as the WTRU moves and a new EDN/EAS needs to be selected.

The examples above describe how a device, or an EEC that is hosted on the device, interacts with an ESF/EEC in a cp-WTRU. It should be appreciated that the function that interacts with the ESF/EEC in cp-WTRU may alternatively be an Application Client that is hosted in the device. Thus, the functionality that is described above as belonging to a device or an EEC that is hosted on the device may instead, or additionally, be implemented by an Application Client on the device. The procedures between the Application Client on the device and the EEC on cp-WTRU may take place over an EDGE-5 protocol, or reference point.

When an AC that is hosted on a device provides an AC Profile to the EEC/ESF that is hosted on cp-WTRU, the AC Profile may include an indication that the AC is hosted on a device. The indication may be used by the EEC/ESF to filter EES instance(s) that are advertised to the AC. For example, the EEC may only advertise EES(s) to the AC that are associated with an indication that they are suitable for access by devices. The ESF/EEC may know which EES instances are suitable to be accessed by edge services because ECS may provide this information to the EEC during the service provisioning procedure. Alternately, or additionally, the ESF/EEC may provide the “local device indication” to ECS when the AC profile is sent to ECS and ECS can use the indication to filter which EES instances are advertised to the EEC.

Similarly, an EEC that is hosted on the device may provide a “local device indication” to the ESF/EEC that is hosted on cp-WTRU.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method performed in a wireless transmit receive unit (WTRU) for providing an Edge Sharing Service (ESS) via a local connection, the method comprising:
reserving resources for a locally connecting device responsive to a registration request from the locally connecting device;
discovering and connecting to at least one edge data network (EDN) providing services required by the locally connecting device, wherein the connecting is via an edge enablement layer;
selecting an edge application server (EAS) and service continuity method on behalf of the locally connecting device; and
providing a registration response to the locally connecting device to allow the locally connecting device to access edge services over the local connection using the resources reserved for the device.

2. The method of claim 1, further comprising requesting Edge Sharing Function (ESF) via an edge enabler client (EEC) registration and receiving an EEC response.

3. The method of claim 2, wherein the EEC response includes connectivity information allowing the locally connecting device to access a service provided by the selected EAS.

4. The method of claim 1, further comprising authenticating and authorizing the device to access edge services.

5. The method of claim 1, further comprising discovering edge services on behalf of the locally connecting device.

6. The method of claim 1, further comprising providing the locally connecting device with an address of a selected EAS.

7. The method of claim 1, further comprising configuring the required connectivity for the locally connecting device to access the EAS.

8. The method of claim 1, wherein the resources reserved for the device include at least one of processing, memory and a configuration needed to keep the registration alive.

9. The method of claim 1, wherein the resources reserved for the device enable discovery of the at least one of the EDN and the EAS, enable the locally connecting device traffic to be sent to the at least one of the EDN and the EAS, and enable service continuity.

10. The method of claim 9, wherein the service continuity includes connectivity with the at least one of the EDN and the EAS managed as the WTRU moves and a new at least one of the EDN and the EAS needs to be selected.

11. A wireless transmit receive unit (WTRU) for providing an Edge Sharing Service (ESS) via a local connection, the WTRU comprising:
a transceiver; and
a processor communicatively coupled to the transceiver, the transceiver and the processor configured to:
reserve resources for a locally connecting device responsive to a registration request from the locally connecting device;
discover and connect to at least one edge data network (EDN) providing services required by the locally connecting device, wherein the connection is via an edge enablement layer;
select an edge application server (EAS) and service continuity method on behalf of the locally connecting device; and
provide a registration response to the locally connecting device to allow the locally connecting device to access edge services over the local connection using the resources reserved for the device.

12. The WTRU of claim 11, wherein the transceiver and the processor are further configured to request Edge Sharing Function (ESF) via an edge enabler client (EEC) registration and receiving an EEC response.

13. The WTRU of claim 12, wherein the EEC response includes connectivity information allowing the locally connecting device to access a service provided by the selected EAS.

14. The WTRU of claim 11, wherein the transceiver and the processor are further configured to authenticate and authorize the device to access edge services.

15. The WTRU of claim 11, wherein the transceiver and the processor are further configured to discover edge services on behalf of the locally connecting device.

16. The WTRU of claim 11, wherein the transceiver and the processor are further configured to provide the locally connecting device with an address of a selected EAS.

17. The WTRU of claim 11, wherein the transceiver and the processor are further configured to configure the required connectivity for the locally connecting device to access the EAS.

18. The WTRU of claim 11, wherein the resources reserved for the device include at least one of processing, memory and a configuration needed to keep the registration alive.

19. The WTRU of claim 11, wherein the resources reserved for the device enable discovery of at least one of the EDN and the EAS, enable for the locally connecting device traffic to be sent to the at least one of the EDN and the EAS, and enable service continuity.

20. The WTRU of claim 19, wherein the service continuity includes connectivity with the at least one of the EDN and the EAS managed as the WTRU moves and a new at least one of the EDN and the EAS needs to be selected.
